(19) United States
(12) Patent Application Publication
(10) Pub. No.: US 2015/0034545 A1
(43) Pub. Date: Feb. 5, 2015

(54) Water Purifiers Having Ultraviolet Light Emitting Diodes

(71) Applicant: SEOUL VIOSYS CO., LTD., Ansan-si (KR)

(72) Inventors: Jung Yeol Park, Ansan-si (KR); Young Hwan Son, Ansan-si (KR); Seong Min Lee, Ansan-si (KR); Jae Seon Yi, Ansan-si (KR); Jong Hyun Koo, Ansan-si (KR); Sang Hee Cho, Ansan-si (KR); Ju Won Yoo, Ansan-si (KR); Sung Lim Cho, Ansan-si (KR); Jong Rack Kim, Ansan-si (KR)

(21) Appl. No.: 14/445,355

(22) Filed: Jul. 29, 2014

(30) Foreign Application Priority Data
Jul. 30, 2013 (KR) 10-2013-0090513

(51) Int. Cl. C02F 1/32; C02F 1/00

(52) U.S. Cl. CPC C02F 1/325; C02F 1/001; C02F 1/002; C02F 2201/32; C02F 2201/3228; C02F 2201/3227; C02F 2201/3225; C02F 2201/3222; C02F 2307/10; C02F 2303/04
USPC 210/251

(57) ABSTRACT

A water purifier that includes a housing having an inlet and an outlet opposing each other, a filter disposed in the housing and connected to the inlet to reduce the flow rate of water introduced into the filter from the inlet, a separator disposed in the housing to store water discharged from the filter, a supply conduit disposed in the housing and connected to a central portion of the separator to provide a path through which the water in the separator is drained, and an ultraviolet light emitting diode (UV LED) module disposed in the housing to irradiate UV rays toward the water stored in the separator.

### CROSS-REFERENCE TO RELATED APPLICATIONS

The present application claims priority under 35 U.S.C 119(a) to Korean Application No. 10-2013-0090513, filed on Jul. 30, 2013, in the Korean intellectual property Office, which is incorporated herein by reference in its entirety.

### BACKGROUND

1. Technical Field

Embodiments of the present disclosure relate to water purifiers and, more particularly, to water purifiers that use ultraviolet (UV) light sources.

2. Related Art

As it becomes more difficult to use raw water as drinking water because of environmental pollution, the use of water purifiers and mineral water have become widespread. In particular, water purifiers rather than the mineral water may be widely used in houses, restaurants, offices and construction sites because utilizing the water purifiers is more advantageous than purchasing the mineral water in terms of cost. The water purifier may be connected to a water pipe supplying the raw water or a raw water tank temporarily storing the raw water to filter out impurities in the raw water. The water purifier may additionally include a cooler for cooling the water and/or a heater for heating the water.

Impurities such as heavy metals in the raw water may be chemically and physically filtered by a filter included in the water purifier. For example, the filter of the water purifier may filter the impurities in the raw water by adsorbing and decomposing the impurities in the raw water. Recently, ultraviolet (UV) rays have been used to remove or sterilize bacteria and viruses in the raw water.

### SUMMARY

This summary is intended to provide an overview of the subject matter of this patent, and is not intended to identify essential elements or key elements of the subject matter, nor is it intended to be used to determine the scope of the claimed embodiments. The proper scope of this patent may be ascertained from the claims set forth below in view of the detailed description below and the drawings.

According to some embodiments, a water purifier includes a housing having an inlet and an outlet opposing each other, a filter disposed in the housing and connected to the inlet to reduce the flow rate of water introduced into the filter from the inlet, a separator disposed in the housing to store water discharged from the filter, a supply conduit disposed in the housing and connected to a central portion of the separator to provide a path through which the water in the separator is drained, and an ultraviolet light emitting diode (UV LED) module disposed in the housing to irradiate UV rays toward the water stored in the separator. The UV LED module is disposed to be adjacent to the supply conduit.

According to further embodiments, a water purifier includes a housing having an inlet and an outlet opposing each other, a filter disposed in the housing and connected to the inlet to reduce the flow rate of water introduced into the filter from the inlet, a first separator disposed in the housing to store water discharged from the filter, a supply conduit disposed in the housing and connected to a central portion of the first separator to provide a path through which the water in the first separator is drained, a first ultraviolet light emitting diode (UV LED) module disposed in the housing to irradiate UV rays toward the water stored in the first separator, a second separator disposed in the housing to store water discharged from the supply conduit, and a second UV LED module disposed in the housing to irradiate UV rays toward the water stored in the second separator. The first UV LED module is disposed adjacent to an upper portion of the supply conduit and the second UV LED module is disposed adjacent to a lower portion of the supply conduit.

### BRIEF DESCRIPTION OF THE DRAWINGS

Embodiments of the inventive concept will become more apparent in view of the attached drawings and accompanying detailed description, in which:

FIG. 1 is a schematic view illustrating an embodiment of a purifying system including a water purifier;

FIG. 2 is a cross-sectional view illustrating an embodiment of a water purifier;

FIG. 3 is an exploded perspective view of the water purifier shown in FIG. 2; and

FIG. 4 is a perspective view illustrating a separator of the water purifier shown in FIG. 2.

### DETAILED DESCRIPTION OF THE EMBODIMENTS

For clarity, the detailed descriptions herein describe certain exemplary embodiments, but the disclosure in this application may be applied to any water purifying system comprising certain of the features described herein and recited in the claims. In particular, although the following detailed description describes certain exemplary embodiments of water purifying systems, it should be understood that other embodiments may have different structures, forms and configurations. In the drawings, the widths, lengths and thicknesses of layers and regions may be exaggerated for clarity.

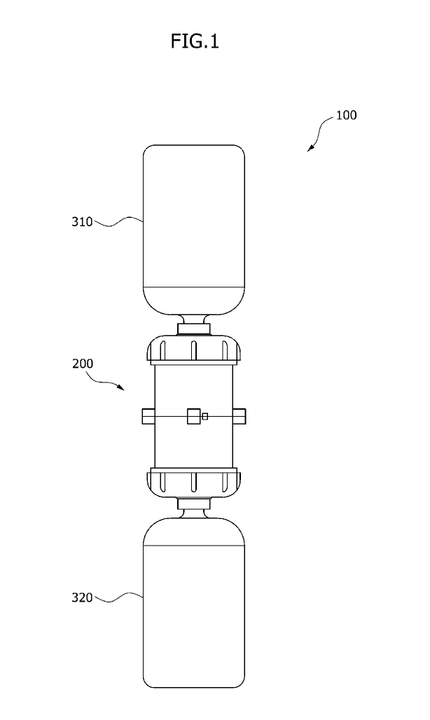

FIG. 1 is a schematic view illustrating an embodiment of a purifying system 100 including a water purifier. Referring to FIG. 1, the purifying system 100 may include a water purifier 200 having UV LEDs, a first water tank 310 connected to an inlet of the water purifier 200, and a second water tank 320 connected to an outlet of the water purifier 200. The first water tank 310 may correspond to a reservoir in which water to be purified is stored. The second water tank 320 may correspond to a reservoir in which water purified by the water purifier 200 is stored. In different embodiments, the shapes of the first and second water tanks 310 and 320 may be different.

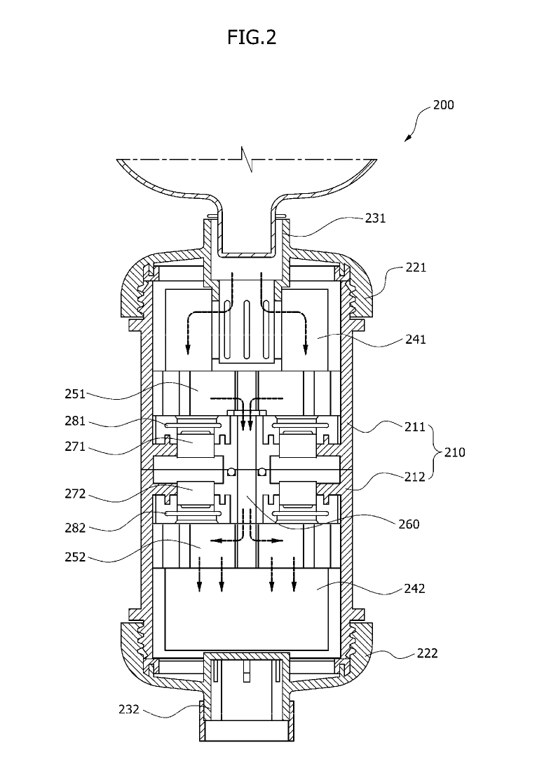

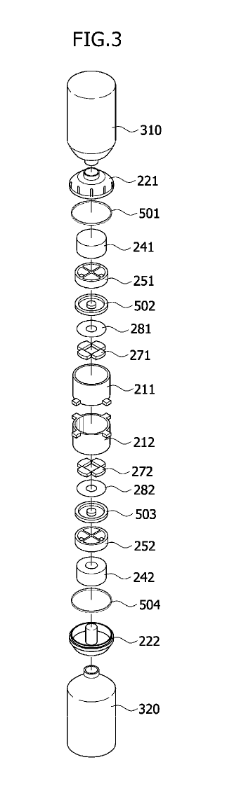

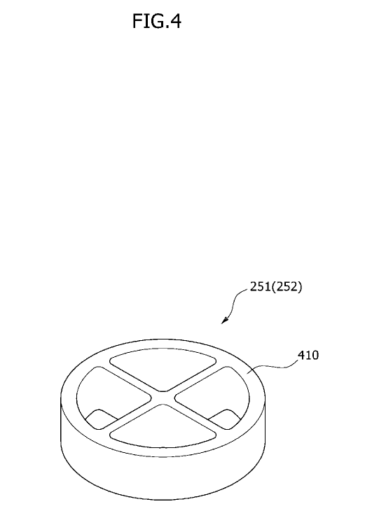

FIG. 2 is a cross-sectional view illustrating the water purifier 200 of FIG. 1, and FIG. 3 is an exploded perspective view of the water purifier 200 shown in FIG. 2. In addition, FIG. 4 is a perspective view illustrating a separator 251 or 252 of the water purifier 200 shown in FIG. 2. In FIG. 2, the arrows denote the directions that water flows in the water purifier 200.

Referring to FIGS. 2 and 3, the water purifier 200 may include a housing 210 that protects and supports its internal components. In this embodiment, the housing 210 may include an upper housing 211 and a lower housing 212. However, in other embodiments, the housing 210 may be a single unified housing. An upper cap 221 may be disposed on the upper housing 211 to close an upper opening of the upper housing 211. The upper cap 221 may have an inlet 231 penetrating a central portion thereof. As described with reference to FIG. 1, the first water tank 310 may be connected to the water purifier 200 through the inlet 231. A lower cap 222 may be disposed below the lower housing 212 to close a lower opening of the lower housing 212. The lower cap 222 may have an outlet 232 penetrating a central portion thereof. As described with reference to FIG. 1, the second water tank 320 may be connected to the water purifier 200 through the outlet 232.

A first filter 241 may be disposed in an upper portion of an inside space of the upper housing 211. The first filter 241 may primarily purify the raw water which is introduced into the upper housing 211 through the inlet 231. In some embodiments, the first filter 241 may be, for example, a sediment filter. The sediment filter used as the first filter 241 may mechanically and physically filter impurities in the raw water. For example, the first filter 241 may be formed of a high density polypropylene material containing a plurality of pores with sizes ranging from about 5 micrometers to about 20 micrometers to filter impurities or contaminants which are greater than about 5 micrometers to about 20 micrometers. In some embodiments, the density of the polypropylene material may be increased to reduce the flow rate of the water passing through the first filter 241.

A first separator 251 may be disposed below the first filter 241. As illustrated in FIG. 4, the first separator 251 may include a frame 410 having a plurality of openings. In some embodiments, the frame 410 may be formed of a material which is capable of reflecting UV rays. For example, the frame 410 may be formed of an aluminum material such as aluminum or an aluminum-containing alloy. Although FIG. 4 illustrates an example in which the frame 410 has four openings, in other embodiments, the frame 410 may have one, two, three, five or more openings. The first separator 251 may act as a reservoir that temporarily stores the water passing through the first filter 241.

A supply conduit 260 may be disposed below a central portion of the first separator 251. The supply conduit 260 may be connected to the central portion of the first separator 251. Thus, the water stored in the first separator 251 may drain into the supply conduit 260 through the central portion of the first separator 251. Accordingly, the water stored in each opening of the first separator 251 may remain for a sufficient time.

A first UV LED module 271 may be disposed adjacent to an upper portion of the first separator 251 and may be configured to irradiate UV rays into the water stored in the first separator 251.

The first UV LED module 271 may include a plurality of UV LEDs. In such a case, the number of the UV LEDs constituting the first UV LED module 271 may be equal to or greater than the number of the openings of the first separator 251. In any case, the UV LEDs of the first UV LED module 271 may be uniformly disposed below the openings of the first separator 251. In some embodiments, the first UV LED module 271 may emit UV rays having a wavelength of about 200 nanometers to about 400 nanometers. A first UV transmission plate 281 may be disposed between the first UV LED module 271 and the first separator 251 to increase transmittance of the UV rays. In some embodiments, the first UV transmission plate 281 may be composed of a quartz material, a tempered glass, or other materials that can transmit UV rays. The UV rays emitted from the first UV LED module 271 may be irradiated to the water in the openings of the first separator 251 through the first UV transmission plate 281 to sterilize the water in the first separator 251. As described above, since the water stored in the first separator 251 drains into the supply conduit 260 through the central portion of the first separator 251, the water stored in each opening of the first separator 251 may remain for a sufficient time. Thus, the UV rays emitted from the first UV LED module 271 may be irradiated to the water in the openings of the first separator 251 for a sufficient time.

A second separator 252 may be disposed below the supply conduit 260. The second separator 252 may have substantially the same configuration as the first separator 251. That is, the second separator 252 may include a frame 410 having a plurality of openings, as illustrated in FIG. 4. Even in such a case, the frame 410 of the second separator 252 may be formed of a material which is capable of reflecting UV rays. For example, the frame 410 of the second separator 252 may be formed of an aluminum material such as aluminum or an aluminum-containing alloy. Although FIG. 4 illustrates an example in which the frame 410 of the second separator 252 has four openings, in other embodiments, the frame 410 of the second separator 252 may have one, two, three, five or more openings. The second separator 252 may act as a reservoir that temporarily stores the water passing through the supply conduit 260.

A second UV LED module 272 may be disposed to be adjacent to a lower portion of the second separator 252 to irradiate UV rays into the water stored in the second separator 252. The second UV LED module 272 may include a plurality of UV LEDs. In such an embodiment, the number of the UV LEDs constituting the second UV LED module 272 may be equal to or greater than the number of the openings of the second separator 252. In any case, the plurality of UV LEDs of the second UV LED module 272 may be uniformly disposed on the openings of the second separator 252. In some embodiments, the second UV LED module 272 may emit UV rays having a wavelength of about 200 nanometers to about 400 nanometers. A second UV transmission plate 282 may be disposed between the second UV LED module 272 and the second separator 252 to increase a transmittance of the UV rays. In some embodiments, the second UV transmission plate 282 may be composed of a quartz material or a tempered glass or other material that can transmit UV rays. The UV rays emitted from the second UV LED module 272 may be irradiated to the water in the openings of the second separator 252 through the second UV transmission plate 282 to sterilize the water in the second separator 252.

A second filter 242 may be disposed below the second separator 252 to further purify the water discharged from the second separator 252. In some embodiments, the second filter 242 may be, for example, a carbon filter. The carbon filter used as the second filter 242 may adsorb heavy metals and impurities to additionally purify the water discharged from the second separator 252 and may release mineral components to improve the drinkability of the purified water. In some embodiments, the second filter 242 may be a complex filter that includes a carbon filter and an ionic filter that are combined with each other. The second filter 242 may be connected to the outlet 232 of the lower cap 222, and the water additionally purified by the second filter 242 may be supplied through the outlet 232 of the lower cap 222. The second UV LED module 272, the second UV transmission plate 282, the second separator 252 and the second filter 242 may be disposed in the lower housing 212.

The elements constituting the water purifier 200 may be sealed or combined with each other by various packing, connecting and sealing means 501, 502, 503 and 504, as illustrated in FIG. 3. Although the above embodiment is described in conjunction with an example in which the first separator 251 is disposed on the second separator 252 and the first and second UV LED modules 271 and 272 are disposed between the first and second separators 251 and 252, the inventive concept is not limited thereto. For example, in some embodiments, the water purifier 200 may not include the second separator 252 and the second UV LED module 272. In some other embodiments, the first and second UV LED modules 271 and 272 may be connected to a car battery through a connector such as a cigarette jack so that the water purifier 200 may be used in an automobile. Moreover, the water purifier 200 may include a chemical battery or a solar cell so that it may be portable.

According to the embodiments, UV rays may be irradiated to water for a sufficient time to successfully sterilize the water.

The embodiments of the inventive concept have been disclosed above for illustrative purposes. Those skilled in the art will appreciate that various modifications, additions and substitutions are possible, without departing from the scope and spirit of the inventive concept as disclosed in the accompanying claims.

What is claimed is:

1. A water purifier comprising:
a housing having an inlet and an outlet opposing each other;
a filter disposed in the housing and connected to the inlet to reduce a flow rate of water introduced into the filter from the inlet;
a separator disposed in the housing to store water discharged from the filter;
a supply conduit disposed in the housing and connected to a central portion of the separator to provide a path through which the water in the separator is drained; and
an ultraviolet light emitting diode (UV LED) module disposed in the housing to irradiate UV rays toward the water stored in the separator,
wherein the UV LED module is disposed to be adjacent to the supply conduit.

2. The water purifier of claim 1, wherein the filter is a sediment filter.

3. The water purifier of claim 1, wherein the separator includes a frame having a plurality of openings.

4. The water purifier of claim 3, wherein the frame is composed of a material which is capable of reflecting UV rays.

5. The water purifier of claim 3, wherein the frame is composed of an aluminum material.

6. The water purifier of claim 3,
wherein the UV LED module includes a plurality of UV light emitting diodes; and
wherein the plurality of UV light emitting diodes are disposed such that UV rays emitting from the plurality of UV light emitting diodes are uniformly irradiated into the plurality of openings of the separator.

7. The water purifier of claim 1, wherein the UV LED module generates UV rays having a wavelength of about 200 nanometers to about 400 nanometers.

8. The water purifier of claim 1, further comprising a UV transmission plate between the separator and the UV LED module.

9. The water purifier of claim 1, further comprising an additional filter disposed between the supply conduit and the outlet to additionally purify the water discharged from the supply conduit.

10. The water purifier of claim 9, wherein the additional filter includes a carbon filter.

11. A water purifier comprising:
a housing having an inlet and an outlet opposing each other;
a filter disposed in the housing and connected to the inlet to reduce a flow rate of water introduced into the filter from the inlet;
a first separator disposed in the housing to store water discharged from the filter;
a supply conduit disposed in the housing and connected to a central portion of the first separator to provide a path through which the water in the first separator is drained;
a first ultraviolet light emitting diode (UV LED) module disposed in the housing to irradiate UV rays toward the water stored in the first separator;
a second separator disposed in the housing to store water discharged from the supply conduit; and
a second UV LED module disposed in the housing to irradiate UV rays toward the water stored in the second separator,
wherein the first UV LED module is disposed adjacent to an upper portion of the supply conduit and the second UV LED module is disposed adjacent to a lower portion of the supply conduit.

12. The water purifier of claim 11, wherein the filter is a sediment filter.

13. The water purifier of claim 11, wherein each of the first and second separators includes a frame having a plurality of openings. 5

14. The water purifier of claim 13, wherein the frame is composed of a material which is capable of reflecting a UV ray.

15. The water purifier of claim 13, wherein the frame is composed of an aluminum material.

16. The water purifier of claim 13,
wherein the first UV LED module includes a plurality of first UV light emitting diodes and the plurality of first UV light emitting diodes are disposed such that UV rays emitting from the plurality of first UV light emitting diodes are uniformly irradiated towards the plurality of openings of the first separator; and
wherein the second UV LED module includes a plurality of second UV light emitting diodes and the plurality of second UV light emitting diodes are disposed such that UV rays emitting from the plurality of second UV light emitting diodes are uniformly irradiated towards the plurality of openings of the second separator.

17. The water purifier of claim 11, wherein each of the first and second UV LED modules generates UV rays having a wavelength of about 200 nanometers to about 400 nanometers.

18. The water purifier of claim 11, further comprising:
a first UV transmission plate between the first separator and the first UV LED module; and
a second UV transmission plate between the second separator and the second UV LED module.

19. The water purifier of claim 11, further comprising an additional filter disposed between the second separator and the outlet to further purify the water discharged from the second separator.

20. The water purifier of claim 19, wherein the additional filter includes a carbon filter.
